(19) United States
(12) Patent Application Publication
(10) Pub. No.: US 2021/0173061 A1
(43) Pub. Date: Jun. 10, 2021

(54) Broadband Ultrasonic Transducer Assembly with Acoustic Lens

(71) Applicant: Airmar Technology Corporation, Milford, NH (US)

(72) Inventors: Dylan Fyler, Hudson, NH (US); Kenneth D. Rolt, Westford, MA (US); Sean M. Frazier, Merrimack, NH (US)

(21) Appl. No.: 16/510,628

(22) Filed: Jul. 12, 2019

(51) Int. Cl. G01S 7/521; G01S 7/524

(52) U.S. Cl. CPC G01S 7/521; G01S 7/524

(57) ABSTRACT

A transducer assembly includes an ultrasonic transducer element having an acoustic radiative surface and configured to emit acoustic radiation over a drive frequency range with a center frequency f_{c}, along a normal to the surface. The assembly also includes a divergent acoustic lens acoustically coupled to the surface at a proximal surface of the lens. The lens receives the radiation at the proximal surface and transmits it through a distal surface. The lens is characterized by a maximum height h, measured from the proximal surface to the distal surface in the direction of the normal, where ¾λ_{c}≤h≤2λ_{c} and λ_{c}=cₗₑₙₛ/f_{c}, where cₗₑₙₛ is a longitudinal sound speed of the center frequency f_{c}. Alternatively or in addition, the acoustic lens may have an acoustic impedance in a range from 1.0 MegaRayls (MRayls) to 2.0 MRayls at f_{c}.

### BACKGROUND

Acoustic transducers are useful for purposes such as locating target objects (e.g., fish), mapping a sea floor or a bottom of another water body, and ultrasonic imaging of a human body, for example. In a broadband ultrasonic transducer that outputs a broadband acoustic pulse, a transducer may be electrically driven with a range of voltage drive frequencies. In addition, where a wide beam is desired, a transducer may be formed by machining an ultrasonic transducer element, such as a lead zirconate titanate (PZT) transducer element.

### SUMMARY

Machining a PZT material to have a non-cylindrical shape is relatively expensive, and existing designs are not optimized to have stability in beam width over a range of drive frequencies, such as the range of a broadband drive pulse.

The diameter of a cylindrical PZT material can be reduced to increase the beam width of the transducer, but this results in reduced power handling capability of the device.

Alternatively, instead of machining a PZT material or using a PZT cylinder with a smaller diameter, an acoustic lens may be applied to a disk of PZT material. However, typical acoustic lens designs have problems optimizing beam width. Lenses that attempt only to maximize beam width at a single frequency are generally simple to design because a lens shape can be manipulated in a simulation until a desired directivity is achieved. However, attempting to maximize beam width across a large bandwidth is much more difficult.

Accordingly, an improved transducer assembly that is both inexpensive and does not rely on machining a PZT material is needed. It would be desirable to be able to maximize beam width, and produce an approximately constant beam width, over a range of frequencies for chirp pulse operation for a transducer assembly that is both broadband and has a wide beam. One example application in which such a transducer would be highly desirable is a Synthetic Aperture Sonar system. In that application, an acoustic projector that provides a wide transmit beam without sacrificing power handling capability is needed.

Accordingly, provided herein are embodiment transducer assemblies and related methods for optimizing these transducer assemblies. Embodiments can produce a broad beam having stabilized beam width over a range of frequencies for broadband pulse operation.

In one embodiment, the transducer assembly includes an ultrasonic transducer element having an acoustic radiative surface. The ultrasonic transducer element is configured to emit acoustic radiation over a drive frequency range, along a normal to the acoustic radiator surface, at the frequency range characterized by a center frequency L. The assembly also includes a divergent acoustic lens that is acoustically coupled to the acoustic radiative surface of the ultrasonic transducer element. The acoustic coupling is at a proximal surface of the acoustic lens, and the acoustic lens is configured to receive the acoustic radiation at the proximal surface and to transmit the acoustic radiation through a distal surface of the acoustic lens. The acoustic lens is characterized by a center acoustic wavelength λ_{c}=cₗₑₙₛ/f_{c}, where cₗₑₙₛ is a longitudinal sound speed of the center frequency f_{c} within the acoustic lens. The acoustic lens has a maximum height h, measured from the proximal surface to the distal surface of the acoustic lens in the direction of the normal to the acoustic radiative surface, where ¾≤h≤2λ_{c}. Alternatively, or in addition, the acoustic lens may be characterized by an acoustic impedance in a range from 1.0 MegaRayls (MRayls) to 2.0 MRayls at f_{c}.

In another embodiment, a transducer assembly includes an ultrasonic transducer element having an acoustic radiative surface. The element is configured to emit acoustic radiation as a broadband pulse over a drive frequency range that is characterized by a center frequency f_{c}. The transducer assembly also includes a divergent acoustic lens acoustically coupled to the radiative surface at a proximal surface of the acoustic lens. The acoustic lens receives the acoustic radiation at the proximal surface and transmits the acoustic radiation through a distal surface of the acoustic lens, which is characterized by an acoustic impedance in a range from 1.0 MegaRayls (MRayls) to 2.0 MRayls at f_{c}.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a cross-sectional illustration of an embodiment transducer assembly having a divergent acoustic lens acoustically coupled to an ultrasonic transducer element, the acoustic lens having a height such that beam width is increased significantly and also such that beam shape is relatively stable over a range of drive frequencies of the transducer.

FIG. 1B is a cross-sectional illustration of an embodiment transducer assembly with an acoustic lens having a spherical surface.

FIG. 1C is a graph showing bulk speed versus density for acoustic lens materials with a preferred range for acoustic lenses of embodiments transducer assemblies.

FIG. 2 is a graph illustrating transmit voltage response (TVR) as a function of look direction for various frequencies, calculated by finite element analysis, using a given set of sample parameters including a lens height h=2λ_{c}.

FIG. 3 is a graph illustrating TVR as a function of look direction for various drive frequencies for a transducer with the same parameters as in FIG. 2, except that the acoustic lens has a lens height h=10.3 mm=3λ_{c}/4.

FIG. 4 is a graph illustrating TVR as a function of look direction for various drive frequencies for a transducer with the same parameters as in FIGS. 2-3, except with a lens height h=16.3 mm, a value between in an intermediate range between the ¾ λ_{c} and 2λ_{c} values.

FIG. 5 is a graph illustrating TVR with respect to look direction and frequency for a transducer assembly having an acoustic lens with a surface defined by a Bézier curve.

FIG. 6 is a graph illustrating mean TVR values from 176 kHz to 225 kHz for three different lens shapes, including the h=2λ_{c}=27.5 mm lens case of FIG. 2, the intermediate lens height h=16.3 mm lens case of FIG. 4, and the Bézier curve lens case of FIG. 5.

FIG. 7 is a graph illustrating cross-sectional lens shapes for the four different lenses described in connection with FIGS. 2-6.

FIG. 8A is a graph illustrating an example chirp voltage waveform that may be used to drive a transducer, including in a finite element analysis.

FIG. 8B is a cross-sectional illustration of a transducer assembly that has an acoustic lens whose cross-sectional shape has been optimized via finite element analysis.

FIGS. 9A-9C are cross-sectional illustrations of the transducer assembly of FIG. 8B receiving acoustic reflections from a target object at various angles in simulation.

FIGS. 10A-10C show received voltage signals determined from the numerical analysis for the target angles in FIGS. 9A-9C, respectively.

FIGS. 11A-11C are graphs illustrating receive voltage signals corresponding to the cases of FIGS. 10A-10C, except with matched filtering applied in each case.

FIG. 12A is an illustration of the example match filtered receive signal of FIG. 11A, at 0° look angle, showing a peak in the match filtered receive signal.

FIG. 12B is a graph showing a plotted peak signal for each look angle determined from the graph shown in FIG. 11B, and a peak corresponding to the look angle 14° and the signal illustrated in FIG. 11C.

FIG. 13 is a graph illustrating how design fitness for a particular cross-sectional shape of an acoustic lens may be determined.

FIG. 14 is a graph showing different fitness results for different simulations, as lens shape is changed iteratively.

FIG. 15 is a graph including the same results illustrated in FIG. 14 and further illustrating how a lens defined by Bézier curve shape may be manipulated in an optimization process to achieve a given desired optimum beam pattern and fitness value such as those illustrated and described in connection with FIG. 13.

FIG. 16 is a perspective illustration or photograph of the assembly of FIG. 8B showing the bottom (left) and the top (right) of the assembly after fabrication, wherein the assembly has the optimized acoustic lens fabricated according to the optimized polynomial shape determined from the fitness calculations of FIG. 15.

FIG. 17 is a graph showing an example TVR for an embodiment acoustic transducer assembly, along with example 3 dB fractional bandwidth thereof.

FIG. 18A is an illustration showing example Bézier shapes for acoustic lenses of embodiment acoustic transducer assemblies, including a quadratic Bézier shape (left) and a cubic Bézier shape (right).

FIG. 18B is an illustration showing two different example four-term Bézier curves, each defined by four points P₀-P₃.

FIG. 18C shows a generalized Bézier polynomial that may be used to define a curve, and a surface of an acoustic lens in embodiment assemblies, using n different terms.

FIG. 19 is a polar graph showing an example acoustic broad beam directivity pattern that may be produced by one embodiment acoustic transducer assembly.

FIG. 20 is a graph illustrating an overlay of electrical impedances for two different transducer assemblies, which are identical except that one transducer is combined with an acoustic lens according to an embodiment, while the other is not.

FIG. 21 is a graph showing an overlay of directivity pattern measurements for the two different transducers referenced in connection with FIG. 20.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

### DETAILED DESCRIPTION

A description of example embodiments follows.

### Broadband Acoustic Transducers

As used herein, acoustic transducers characterized by a quality factor “Q” of less than 8 are considered to be “broadband.” Further as used herein, a “broadband” acoustic transducer can operate over a wide frequency band between a high-frequency value and a low-frequency value. In one example, the high- and low-frequency values are 60 kHz and 33 kHz. In another example, the high- and low-frequency values are 176 kHz and 225 kHz, and there are many other high- and low-frequency values within the scope of embodiment broadband acoustic transducers described herein. Broadband acoustic transducers typically generate distinctly crisp acoustic pulses with shorter rise and fall times (faster pulses).

Using broadband acoustic transducer technology, transducer ringing can be diminished, and the Q is usually lower than 8. The resulting crisp pulses allow for superior detection of fish, particularly those that are tightly spaced or suspended very close to the floor of a water body. When used for navigation purposes, broadband transducers also do a better job of imaging the bottom of a water body at all depths, especially in very shallow water. In addition to these benefits, broadband acoustic transducers can generate chirp pulses with high fidelity, which improves the performance of systems using pulse compression signal processing.

### Acoustic Lenses

Acoustic lenses that are intended to increase beam width for narrowband operation (e.g., at a single frequency) are generally simple to design. For a single acoustic frequency, a lens shape generally can be manipulated manually in a simulation until a desired beam directivity is achieved. However, attempting to increase or maximize beam width across a large bandwidth is a much more difficult task. An optimization method is needed to manipulate geometry of the lens. Provided herein is a method that utilizes a fitness function to evaluate beam width of the transducer at each frequency of a broadband drive frequency range.

Simply measuring beam width at discrete frequency steps across a bandwidth of a transducer is not sufficient to characterize its broadband performance. Generally, a given lens design may have a relatively large beam width with on-axis nulls that appear at certain frequencies. These nulls can cause amplitude distortion in a received waveform and hinder performance of a matched filter that is used to process the received signal.

As described hereinafter, instead of simply measuring beam width, an alternative characterization of a transducer assembly may be made. This alternative characterization may include a combination of how well a transducer transduces a voltage waveform into a pressure waveform and how well the reflected pressure waveform is received back into an original waveform. This alternative measurement can be completed by calculating performance when a transducer assembly is driven by a broadband waveform of some given bandwidth and duration, preferably a broadband drive waveform that is similar to a waveform that is desired to be used to drive the transducer assembly in standard operation. A transducer that behaves ideally can be considered to receive a waveform that is identical to the initial voltage waveform that is transmitted.

Description of Certain Embodiment Transducer Assemblies with Acoustic Lenses Capable of Broadband Operation with Stabilized Beam Width

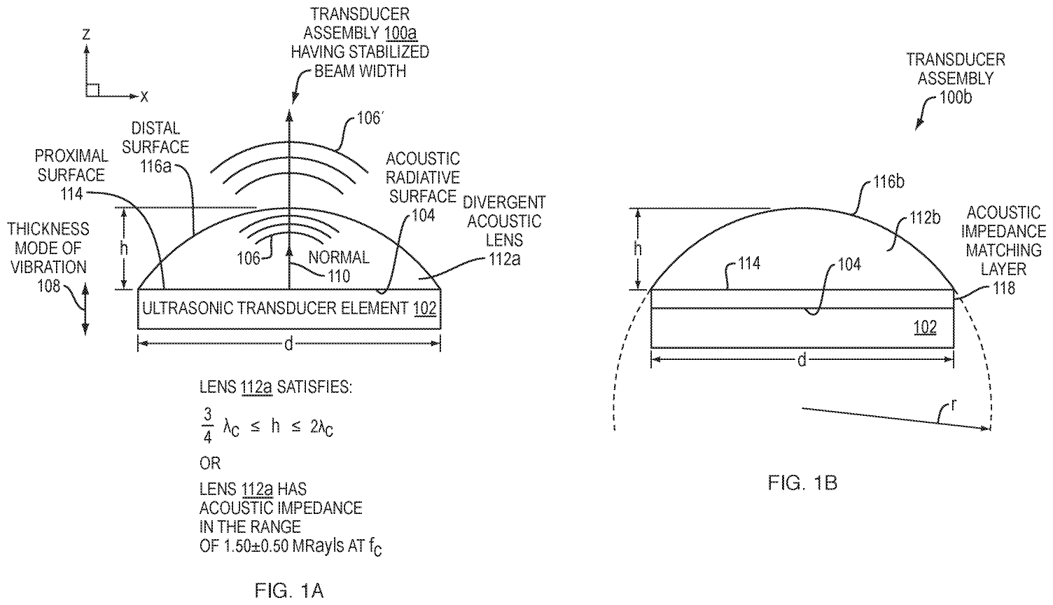

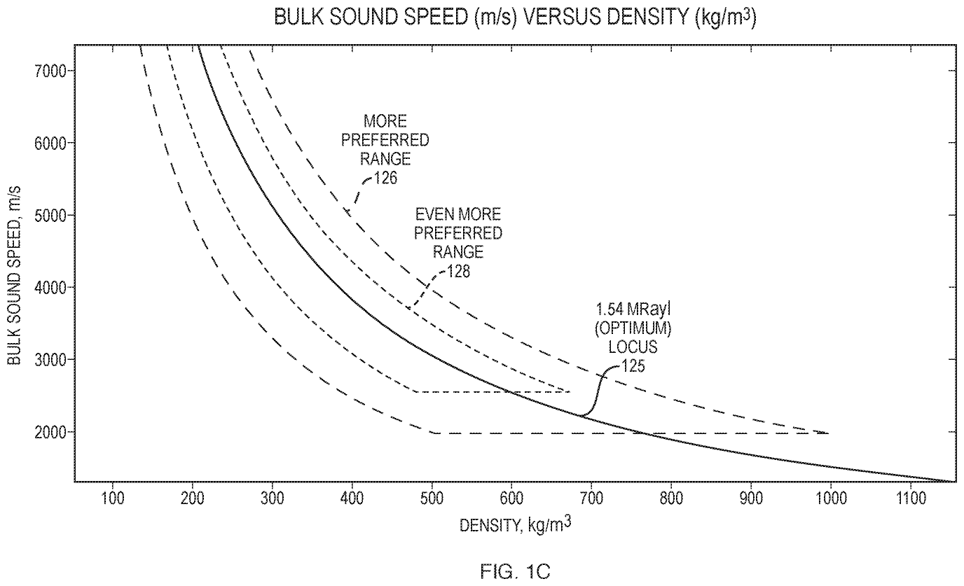

FIG. 1A is a cross-sectional illustration of an embodiment transducer assembly 100a having elements that provide a relatively stabilized beam width over a frequency range of drive frequencies for broadband-pulse operation. The acoustic lens has a height such that beam width is increased significantly and also such that beam shape is relatively stable over a range of drive frequencies of the transducer. The assembly 100a includes an ultrasonic transducer element 102 and a divergent acoustic lens 112a. The ultrasonic transducer element 102 is configured to emit acoustic radiation 106 along a normal 110 to an acoustic radiative surface 104 of the ultrasonic transducer element 102. The element 102 may be formed of a ceramic piezoelectric material or another suitable material. The frequency range is characterized by a center frequency f_{c}, as is understood in the art of broadband ultrasonic signals.

The divergent acoustic lens 112a is acoustically coupled to the radiative surface 104 of the transducer at a proximal surface 114 of the acoustic lens. The acoustic lens 112a is configured to receive the acoustic radiation 106 at the proximal surface 114 and to transmit the acoustic radiation through a distal surface 116a of the acoustic lens. The ultrasonic transducer element 102 may be further configured to emit the acoustic radiation using a thickness mode of vibration 108 of the element 102, which results from thickness fluctuation of the ultrasonic transducer element 102 as it is driven by a drive voltage, as is understood in the art of ultrasonic transducers. In particular, the thickness mode of vibration 108 may be a fundamental thickness mode of vibration or any harmonic of the fundamental thickness mode.

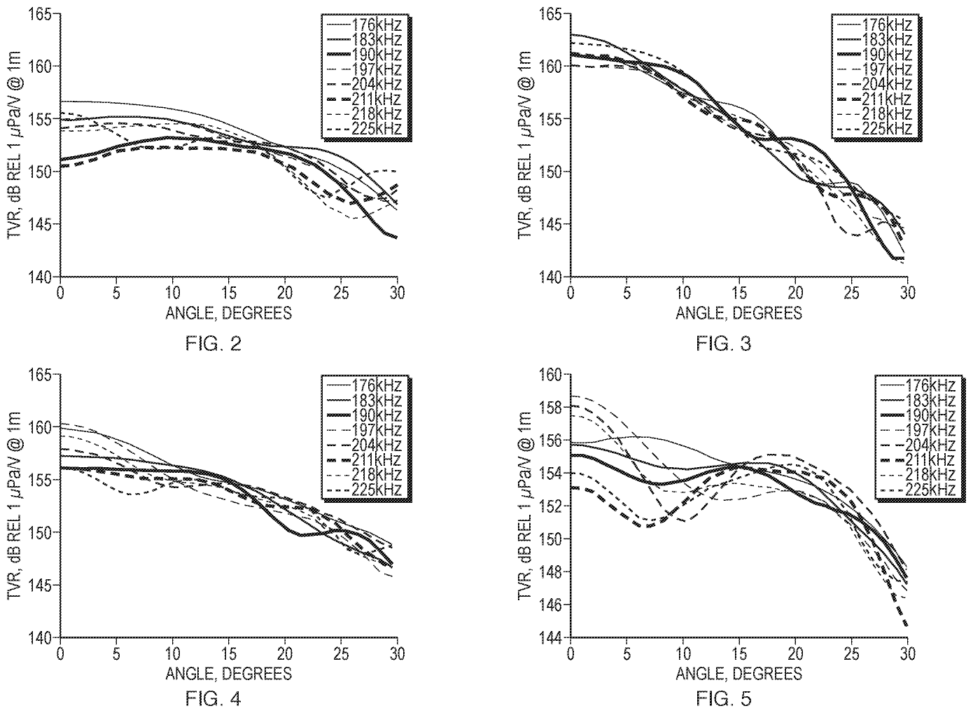

The acoustic lens 112a is characterized by a center acoustic wavelength λ_{c}=cₗₑₙₛ/f_{c}, where cₗₑₙₛ is a longitudinal sound speed of the center frequency f_{c} within the acoustic lens 112a. The acoustic lens has a maximum height h, measured from the proximal surface 114 to the distal surface 116a of the acoustic lens 112a in the direction of the normal 110 to the acoustic radiative surface 104 of the transducer element 102. In one embodiment, the lens 112a satisfies the conditions ¾ λ_{c}≤h≤2λ_{c}. As further described herein in reference to FIGS. 2-7, a lens with a height h in a range from ¾λ_{c} and 2λ_{c} provides an advantageous compromise between tradeoffs of shorter and taller lenses.

As an alternative, or in addition to meeting the condition ¾λ_{c}≤h≤2λ_{c}, in some embodiments, the acoustic lens 112a is characterized by an acoustic impedance in a range of 1.50±0.50 MegaRayls (MRayls) at the center frequency f_{c} (i.e., in a range of 1.0 to 2.0 MRayls). Some reasons for having an acoustic impedance in a range of 1.0 to 2.0 MRayls are described in connection with FIG. 1C, along with additional and alternative preferred ranges for acoustic impedance for various embodiments.

Even more preferably, the acoustic lens 112a may be characterized by an acoustic impedance in a range of 1.25 to 1.75 MRayls at f_{c}. In one embodiment, the acoustic impedance is optimized to match, as closely as possible, the acoustic impedance of seawater, which is approximately 1.54 MRayls, for example. The acoustic impedance of the acoustic lens 112a may further be optimized within a range of ±0.1, ±0.2, ±0.25, or ±0.50 with respect to the acoustic impedance of seawater or fresh water, for example. Some reasons for this are further described in connection with FIG. 1C.

The acoustic lens 112a may have a longitudinal sound speed cₗₑₙₛ within the lens that is greater than 2000 m/s, for example. In other particular embodiments, the longitudinal sound speed cₗₑₙₛ may be greater than or equal to 2500 m/s or greater than or equal to 2700 m/s, for example. In particular, advantageous embodiments have longitudinal sound speed cₗₑₙₛ that is in a range of approximately 2000 m/s to approximately 3000 m/s. Various embodiments have density p for the acoustic lens 112a that is less than 700 kg/m³, such as within a range of 300 kg/m³ to about 700 kg/m³, for example.

In certain embodiments, the divergent acoustic lens 112a is formed of a syntactic foam material. Syntactic foams are particularly advantageous in that they are inexpensive, can be machined easily in a wide variety of shapes, and fall within the density, bulk speed, and acoustic impedance ranges described above and hereinafter in connection with FIG. 1C. As an alternative, however, other embodiments include acoustic lenses formed of one or more composite materials, such as carbon fiber or glass fiber, for example.

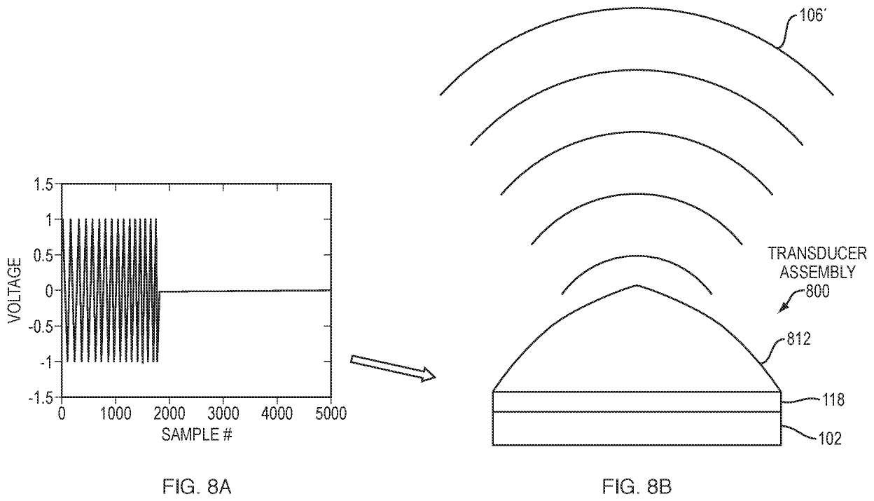

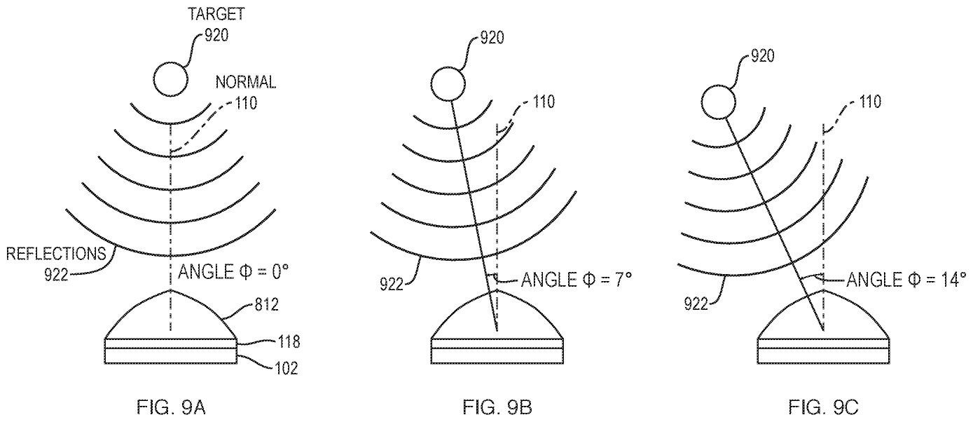

In general, in a cross-section of the acoustic lens embodiments, the distal surface 116a of the acoustic lens may be defined by a partially spherical shape, as in the embodiment of FIG. 1B, a Bézier curve shape, or by a wide variety of other shapes and mathematical functions. In a cross-section of the acoustic lens in some embodiments, the distal surface 116a of the acoustic lens may be defined by a polynomial of second order to tenth order, for example. More particularly, the transducer assembly may include a distal surface 116 of the divergence acoustic lens 112a which, in a cross-section of the acoustic lens such as that illustrated in FIG. 1A, is defined by a polynomial of third order to tenth order, for example. Even more preferably, the polynomial may be of third order to fifth order, such as particularly being fourth order, for example. Distal surfaces of divergent acoustic lenses in various embodiments can have these shapes for various advantages including those described hereinafter. In particular, higher order functional shapes for distal surfaces of lenses can have an advantage of stabilizing beam width over a given range of drive frequencies for broadband pulse operation more flexibly. At the same time, the advantages of higher order functional shapes may be balanced with the advantages of modeling and designing using a lower order polynomial for an optimization process, as optimization with a lower order polynomial may be less intensive computationally. An example optimization process is described in connection with FIGS. 8A through 15, for example. In one embodiment, a cross-section of the acoustic lens has a distal surface defined by one or more Bézier curves, such as those illustrated in FIGS. 7, 8B, 9A-9C, and 16, for example.

As used herein, “3 dB fractional bandwidth” refers to the ratio of the 3 dB bandwidth to the operation frequency. The 3 dB bandwidth is the full width of the frequency spectrum of a transducer assembly at a 3 dB TVR level below the peak TVR level. The operation frequency is considered to be the center frequency L. 3 dB fractional bandwidth, as used herein, is further described by way of example in connection with FIG. 17. In some embodiments, the transducer assembly has a transmit voltage response (TVR) that has an effective 3 dB fractional bandwidth greater than 10%. TVR in other embodiments may have an effective 3 dB fractional bandwidth greater than 20%, for example. The TVR in yet other embodiment assemblies may have an effective 3 dB fractional bandwidth greater than 30%. Further, in additional embodiments, the TVR may have an effective 3 dB fractional bandwidth greater than 40%.

In various embodiments, a beam of acoustic radiation that is output from the acoustic lens 112a may be characterized by a −3 dB beam divergence in a range from about 15° to about 40°. Further, the −3 dB beam divergence may be in a range from about 20° to about 30°, for example. The center frequency f_{c} may be on the order of 200 kHz, and an example range of frequencies for a broadband pulse may be 176 kHz-225 kHz, for example. However, other center frequencies are possible, such as a 50 kHz center frequency, and other frequency ranges are possible for a broadband pulse, as will be understood by those of skill in the art of acoustic broadband pulses in view of this disclosure.

FIG. 1B is a cross-sectional illustration of a transducer assembly 100b. The assembly 100b is similar to the assembly 100a, but the assembly 100b has a divergent acoustic lens 112b that is characterized by a distal surface 116b that is particularly spherical, having a radius r. The transducer assembly 100b also features an acoustic impedance matching layer 118 that is optional but preferable. The acoustic lens 112b is acoustically coupled to the acoustic radiative surface 104 of the transducer element 102 via the acoustic impedance matching layer 118. The matching layer is preferred for improving acoustic coupling between the divergent acoustic lens 112b and the element 102 and also to avoid acoustic reflections between the lens and the element to the extent possible. However, in other embodiments, such as in the assembly 100a in FIG. 1A, the acoustic coupling may be provided by other means, such as another type of secure bonding, a press coupling, or otherwise simply by physical contact between the proximal surface of the divergent acoustic lens and the transducer element.

FIG. 1C is a graph showing bulk speed (in meters per second) versus density (in kilograms per cubic meter). Acoustic impedance of an acoustic lens is equal to a product of acoustic wave speed in a material and the density of the material. Accordingly, in order to maintain a given acoustic impedance in a lens, as acoustic wave speed increases with material selection, density must be decreased.

The graph of FIG. 1C shows a curve 125 including various values of speed and density for acoustic lenses for which the acoustic impedance will equal 1.54 MRayls, the approximate acoustic impedance of seawater. If an acoustic lens is desired to be used in seawater having an acoustic impedance of 1.54 MRayls, then the curve 125 represents preferred values of acoustic impedance of acoustic lenses in embodiments. In this case, for an acoustic lens having acoustic impedance that matches this value at the center frequency f_{c}, the acoustic lens 112a will transmit the center frequency f_{c} completely into the water (or into urethane or another encapsulating material that may encapsulate the lens 112a, for example) and will not be reflected back into the lens. As is understood, reflections back into the lens can cause a change in impedance to the transducer 102, which is undesirable.

As will be understood, if the transducer assembly 100a is to be configured for transmitting acoustic radiation into seawater having a different acoustic impedance (due to having different concentrations of solutes or different temperatures, for example) or into freshwater, for example, then the acoustic impedance will be different from the 1.54 MRayls value, and a divergent acoustic lens may be designed or modified accordingly with acoustic impedance to match the desired medium as closely as possible.

For reasons described more fully hereinafter, it is further preferable for a divergent acoustic lens to have height h as small as possible. Materials having faster bulk speed will refract the wave sufficiently to produce a wide acoustic beam even when using a relatively thinner acoustic lens having a relatively small height h. Further, thinner acoustic lenses may have smaller variation in beam width over a broadband frequency range of operation for an acoustic chirp pulse. In contrast, slower materials will require thicker lenses to produce sufficient refraction and may have greater variation in beam width over the broadband frequency range. Accordingly, in more preferred embodiments, the bulk speed of the divergent acoustic lens 112a is greater than 2000 m/s (corresponding to a density of the divergent acoustic lens 112a that is less than or equal to about 770 kg/m³ for the example acoustic impedance of 1.54 MRayls). These values are illustrated by the more preferred range 126 in FIG. 1C. Still further, it is even more preferable for the bulk speed to be within a higher range for similar reasons, such as greater than or equal to 2500 m/s. Accordingly, in this more preferable range, a divergent acoustic lens in certain embodiments would fall within the even more preferred range 128 illustrated in FIG. 1C, for example.

Beam Width Optimization over a Range of Frequencies

Syntactic foam has previously been utilized in an acoustic lens for a Doppler-based ultrasound transducer. However, in a Doppler ultrasound application, single-frequency operation is typically used since it provides much better results in that application. Lens design in the case of a single operating frequency is much easier and significantly simplifies design of a lens, because a radius for a spherical dome lens, for example, needs only to be adjusted until beam width is sufficiently divergent at the single operating frequency.

The lens design problem is much more complicated when an acoustic transducer assembly, such as the assembly 100a in FIG. 1A, is intended to be operated over a range of frequencies instead of at a single frequency. In this case, it is desirable for a lens to be designed so that it has a relatively constant beam width over a range of frequencies of intended operation, constant beam width transducers are highly desirable in sonar applications, where broadband transmit signals may be used in combination with matched filtering to reduce background noise and improve target range resolution. The inventors have discovered that a range of ¾λ_{c}≤h≤2λ_{c} can provide the needed, enhanced lens performance for relatively constant beam width over a range of frequencies. In order to show this, a lens design may be cast in terms of a transducer with a diameter d and a lens height h, as illustrated in FIG. 1B. In FIG. 1B, with h and d chosen for a transducer, the r for the partially spherical lens shape may be calculated as

$$r = \frac{{d}^{2} + 4 {h}^{2}}{8 h}$$

In order to map h to a range that is related to the operating frequency of the transducer, it can be defined as some multiple of λ_{c}, the acoustic wavelength in the acoustic lens at the center frequency of the device. The larger h is, the greater the beam width of the transducer will be. For very small values of h, the beam width approaches the beam width that would be obtained if no lens were used.

In order to demonstrate the case of an excessively divergent lens, a lens may be generated for a transducer with d=51 mm, a center operating frequency f_{c} of 200 kHz, and a syntactic foam with a longitudinal sound speed of 2750 m/s. The height h of the lens may be set to 2λ_{c}, which translates to

$$h = 2 {λ}_{c} = 2 * \frac{{C}_{lens}}{{f}_{c}} = 2 * \frac{2750}{200 e 3} = 0.0275 m = 27.5 mm$$

FIG. 2 is a graph illustrating TVR with respect to frequency and look direction, as determined using the above sample parameters, including h=2λ_{c} by employing finite element analysis. As can be seen in FIG. 2, the beam shape for an excessively divergent lens with height h=2λ_{c} varies greatly across the bandwidth of the transducer. This results from several issues that a lens of this height introduces into a transducer assembly. One issue is that, while a longitudinal wave traveling through the lens has almost no reflection at the lens-transmission medium interface, transverse waves traveling inside the lens will reverberate, causing varying impact on the beam pattern as the frequency changes. Another factor is that the acoustic absorption of an acoustic lens material, and particularly of a syntactic foam lens material, may increase with frequency. In this case, more energy is removed at the high end of the bandwidth than at the low end. As still another factor, as drive frequency increases, a syntactic foam lens becomes more divergent due to the lens appearing acoustically larger. These three factors demonstrate that there is a tradeoff between lens height and consistency of the acoustic beam transmitted therethrough. A lens should be relatively thicker (of greater height h) in order to produce a beam that is relatively divergent. However, as the lens height increases, the output beam varies more with frequency.

FIG. 3 is a graph illustrating TVR as a function of look direction and frequency for a transducer with the same characteristics as described in connection with FIG. 2, except that the lens has a lens height h=10.3 mm=3λ_{c}/4. Accordingly, FIG. 3 illustrates results for a smaller-lens-height end of a design range. Similar to the results illustrated in FIG. 2, a finite element model was used to simulate a transducer with the h=3λ_{c}/4 to obtain the results of FIG. 3.

FIG. 3 illustrates that by reducing lens height, the consistency of a beam output from a transducer assembly that includes such a lens is improved in exchange for the maximum beam width. Such a low-profile lens design represents a smaller end of potential lens heights that may be used realistically. A nominal −3 dB beam width for the frequencies shown in FIG. 3 is about 20°. Without any lens at all, the beam width of the transducer is 8°. If an even smaller lens were implemented in order to achieve a beam width of 15°, the small increase in beam width would not warrant the extra material, cost, and labor that may be required to add an acoustic lens to the transducer assembly.

FIGS. 2-3, therefore, show example results for the thickest and thinnest acoustic lenses, respectively, that are contemplated to be used in embodiment transducer assemblies in order to increase beam width. Highly desirable transducer assemblies described herein, therefore, include acoustic lenses with lens heights in the range of about ¾λ_{c} to about 2λ_{c}.

FIG. 4 is a graph illustrating TVR as a function of look direction and frequency for a transducer assembly with a lens height h=16.3 mm, a value in an intermediate range between the ¾λ_{c} and 2λ_{c} values. The example lens height 16.3 mm provides a compromise between the tradeoffs with taller and shorter lenses. The nominal −3 dB beam width for the lens height of 16.3 mm is 27° (7° greater than with the ¾λ_{c} design. The variation in TVR is kept within a 5 dB range over the bandwidth of drive frequencies, which is 176 kHz-225 kHz in this example case. This is in contrast to a 7 dB variation in TVR over the bandwidth for the 2λ_{c} design.

While lens heights in the ¾λ_{c} to 2λ_{c} range provide more ideal results than the designs at the ends of this range, further unique solutions in the ¾λₖ to 2λ_{c} range with lens profile shapes that are not spherical can further improve performance of embodiment transducer assemblies. Various unique solutions that further improve performance may be found by using an optimization algorithm and a fitness function, as described further hereinafter. A fitness function (for example, a function that ranks a performance of each lens with a single value ranging from zero to infinity, with zero being best) may be designed to provide the widest −3 dB beam width while also maximizing a signal level at maximum response axis (MRA).

In one embodiment, a lens may be defined by a Bézier curve. A Bézier curve is convenient since this is a shape that may be controlled by a few terms for optimization. In a particular case, a Bézier curve may be controlled by four terms, which may be used as input parameters for the optimization algorithm.

FIG. 5 is a graph illustrating TVR with respect to look direction and frequency for a transducer assembly having a lens defined by a Bézier curve. From the results illustrated in FIG. 5, it is unclear whether there is an improvement in transducer performance by changing the shape from a sphere, as in FIG. 1B (for which results are shown in FIGS. 2-4 for various lens heights) to an optimized Bézier curve. Beam width, as can be derived from FIG. 5 readily, is large, but there is also more variation in TVR at MRA than there is for the h=16.3 mm shape, the results of which are shown in FIG. 4. In order to evaluate and compare various cross-sectional lens shapes better, the TVR with respect to look direction may be averaged over the range of operating frequencies (in this case, from 176 kHz to 225 kHz) in order to obtain a mean directivity pattern.

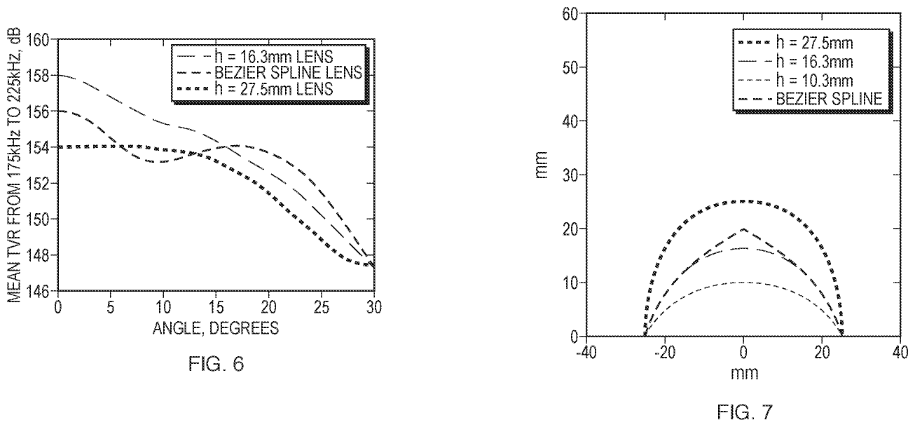

FIG. 6 is a graph illustrating mean TVR values from 176 kHz to 225 kHz for three different acoustic lens shapes, including the h=2λ_{c}=27.5 mm spherical acoustic lens case of FIG. 2, the intermediate lens height h=16.3 mm spherical acoustic lens case of FIG. 4, and the Bézier curve acoustic lens case of FIG. 5. FIG. 6 highlights the benefits of using an optimized non-spherical shape in order to construct a lens with a desirable cross-sectional shape. While the 16.3 mm lens and the Bézier curve lens have similar overall dimensions, FIG. 6 demonstrates that increased complexity in the lens shape is used to sacrifice TVR level in the 0° to 15° range, but increase TVR level in the 15° to 30°. The net result of this is increasing the mean TVR beam width of 24° for the 16.3 mm to 44° for the Bézier curve lens. Accordingly, as demonstrated by FIG. 6, the Bézier curve design completely outperforms the 27.5 mm lens design, with higher mean TVR at almost every look direction.

FIG. 7 is a graph illustrating cross-sectional lens shapes for the four different lenses described in connection with FIGS. 2-6. This includes the spherical acoustic lenses of height h=27.5 and h=10.3 mm, the spherical acoustic lens of intermediate h=16.3 mm, and the Bézier curve shape for which results are shown in FIGS. 5 and 6. In order to summarize these results, it is pointed out that there is an ideal lens height range for acoustic sonar transducers, a height range that lies between spherical shapes lies between heights of two spherical shapes having respective heights ¾λ_{c} and 2λ_{c}. Lenses falling outside this range of heights are either insignificantly divergent or extremely divergent, with directivity that varies greatly with frequency. Within the ¾λ_{c} to 2λ_{c} range of acoustic lens heights, however, there are unique, non-spherical lens shapes that may be determined by using an optimization function to optimize shape for to minimize beam width variation over the range of frequency operation. In one example, a unique, non-spherical lens shaped includes a Bézier curve shape.

### Further Optimization of Acoustic Lens Shape

FIGS. 8A-17 and the description thereof provide an example procedure for optimizing lens shape in order to make a beam as wide and as uniform as possible over a range of frequencies used for a chirped, broadband acoustic beam. In particular, a simulation may be performed to determine an optimized lens shape numerically.

FIG. 8A is a graph illustrating an example chirped voltage waveform that may be used to drive a transducer. A simulation may be driven with this user-defined chirp drive signal. This chirp drive signal may be chosen based on how the transducer assembly will be driven in operation. For example, the range of drive frequencies for the simulation may be the same as the range of frequencies and overall chirp voltage waveform that may be used for the transducer assembly to be designed. The chosen drive voltage waveform is input into a finite element model of the transducer, and a simulation is performed to determine the pressure waveform that may be generated by the transducer assembly from the drive voltage input.

FIG. 8B is a cross-sectional illustration of a transducer assembly 800 that has an acoustic lens 812 whose cross-sectional shape is to be optimized. From the simulation, and based on the chirp voltage input illustrated in FIG. 8A, for example, the pressure waveform of the acoustic radiation 106′ that is output from the distal surface of the acoustic lens 812 may be calculated.

FIGS. 9A-9C are cross-sectional profiles of the transducer assembly 800 of FIG. 8B receiving acoustic reflections from a target object 920 at various angles in simulation. FIG. 9A illustrates the transducer assembly 800 receiving the reflected acoustic radiation 922 from the target 920 at an angle of 0° with respect to the normal 110 to the ultrasonic transducer to the proximal surface of the ultrasonic transducer. FIG. 9B illustrates the same transducer receiving, in simulation, the reflected radiation 922 from the same target 920 at an angle of 7° with respect to the normal 110. Similarly, FIG. 9C illustrates the assembly 800 receiving the reflected acoustic radiation 922 from the target 920 at an angle of 14° with respect to the normal 110. Accordingly, the received signal may be simulated for various target angles by simulation based on the results from the transmission simulation illustrated in FIGS. 8A-8B. Thus, reflections from a given target at various angles may be solved for numerically, and FIGS. 9A-9C illustrates some of these angles. In practice, many more angles between 0 and 14°, and beyond 14°, may be used to determine uniformity.

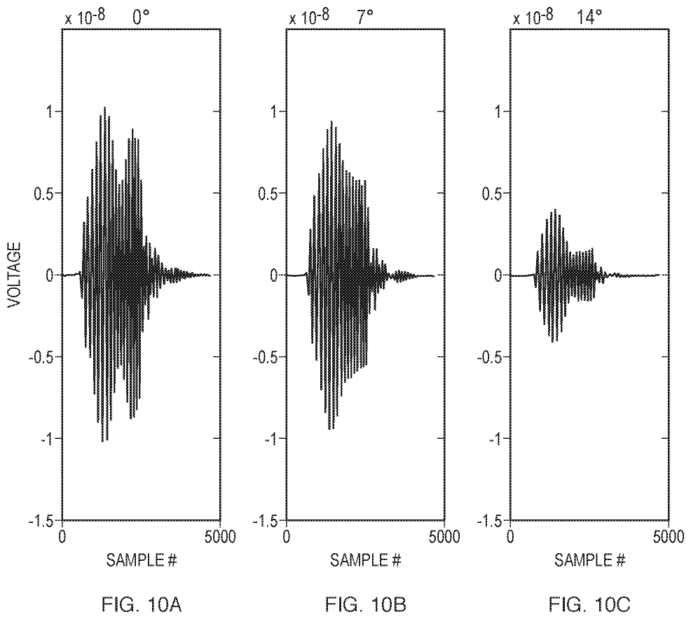

FIGS. 10A-10C show the calculated received voltage signal, determined from the numerical analysis, for the angles for the target angles in FIGS. 9A-9C, respectively. Using the extrapolated pressure and the impedance of the transducer, the echo voltage can be determined using Fourier analysis. While only three receive angles are illustrated in FIGS. 9A-9C and 10A-10C, the received voltage waveform preferably can be calculated for many more angles, such as at 10° increments, 5° increments, 3° increments, 1° increments, or smaller increments, for example. For example, in one embodiment procedure, 1° increments are used, such that the receive voltage is determined for angles equal to 0°, 1°, 2°, . . . , up to a maximum angle of interest from the normal, such as 90°, 80°, 70°, 60°, 50°, 45°, 35°, 25°, 15°, 14°, etc.

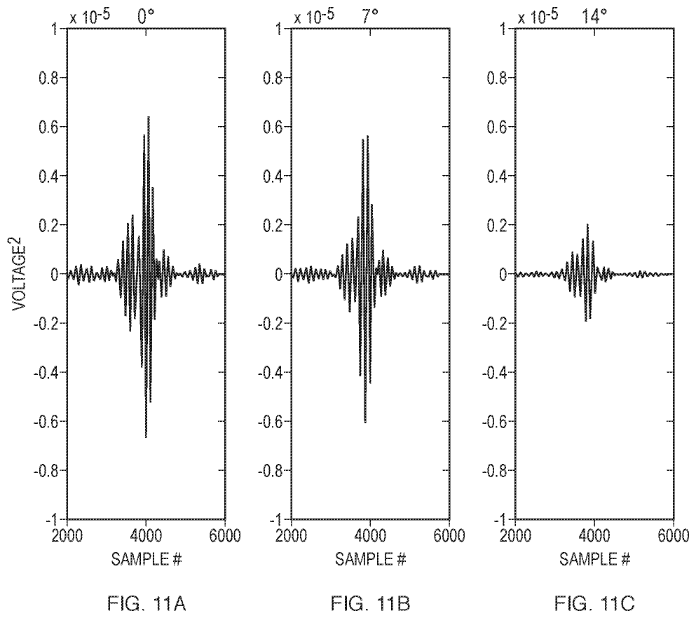

FIGS. 11A-11C are graphs illustrating receive voltage signals corresponding to the cases of FIGS. 10A-10C, except with matched filtering applied in each case. Matched filtering can be performed on each received echo signal using the drive voltage as the signal replica. Using the drive voltage as the replica, matched filtering may be applied to the raw receive voltage signals illustrated in FIGS. 10A-10C at each target angle φ step, such as the steps 0°, 7°, and 14° previously described, for example. From the graphs of FIGS. 11A-11C, the peak voltage of the match filtered signals may be calculated for each look direction, and these peak voltage values may be used to determine the chirp directivity.

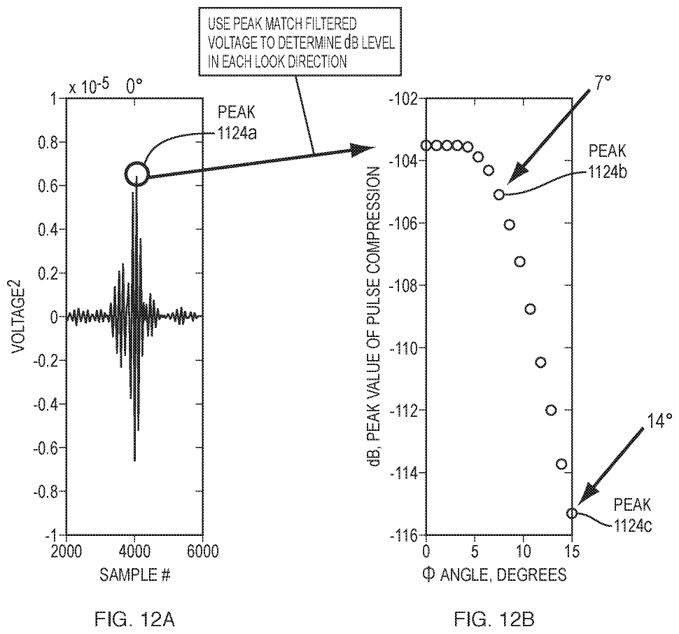

FIG. 12A is an illustration of the example match filtered receive signal of FIG. 11A, at 0° look angle φ, showing a peak 1124a in the match filtered receive signal. Similarly, a peak in each of the match filtered signals illustrated in FIGS. 11A-11C, corresponding to 0°, 7°, and 14°, respectively, or at other increments for the calculation, such as 1°, may be determined.

FIG. 12B is a graph showing a plotted peak signal for each look angle, including the peak 1124a for 0° look angle φ, a peak 1124b for the 7° look angle φ, determined from the graph shown in FIG. 11B, and a peak 1124c corresponding to the look angle φ=14° and the signal illustrated in FIG. 11C. Since pressure may be extrapolated at each look direction φ, this process may be repeated for each possible look angle φ. The peak voltage from the match filtering signals may be used to determine the dB level at each angle φ step. The resultant graphed pattern, illustrated in FIG. 12B, is the beam pattern determined for the chosen chirp drive signal. If enough target angle φ steps are used, a clear directivity pattern, such as that illustrated in FIG. 12B, may be determined. Unlike single frequency beam patterns, chirp beam pattern represents the directivity of the transducer assembly 800 when driven by the chirp waveform illustrated in FIG. 8A.

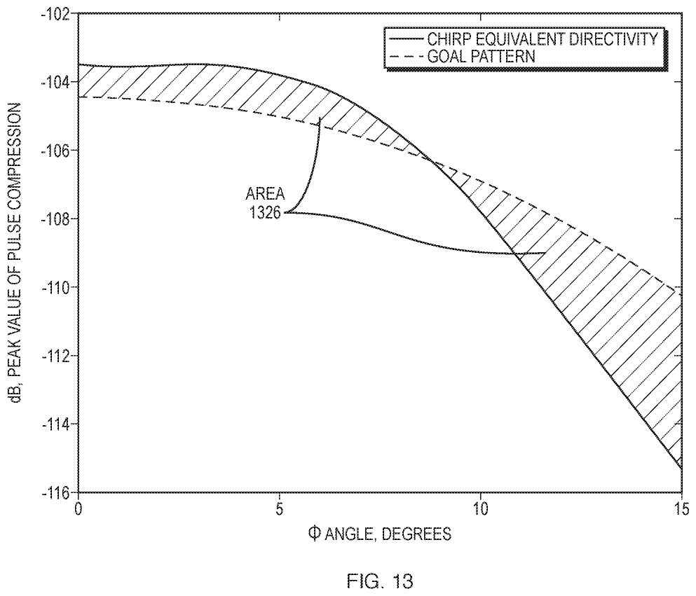

FIG. 13 is a graph illustrating how design fitness for a particular cross-sectional shape of the lens 812 may be determined. In particular, FIG. 13A shows two curves and an area 1326 between the curves. A first curve, shown as a dashed line, is a goal beam pattern, showing intensity (in dB) evaluated with respect to the peak value of pulse compression, as a function of look angle φ. The goal pattern may be selected by the designer based on a predetermined desired beam shape. A second curve, shown as a solid line, is the curve developed from the plot shown in FIG. 12B (in dB) with respect to the peak value of pulse compression, and this curve is determined at each various look angles φ. In order to determine the fitness of a particular lens shape design, the area 1326 between the two curves may be calculated. The fitness value, represented by the area 1326 between the curves, may be used as an input to a next optimization iteration, in which the calculations of FIGS. 8A-13 may be repeated for a different lens shapes. In this manner, during an optimization procedure, the desirability of a particular lens shape design may be determined and iterated accordingly. An optimal design may be considered to be a design that has a fitness of 0, with no space between the goal pattern represented by the dashed line and the chirp receive pattern calculated for the particular lens shape (e.g., the solid line of FIG. 13).

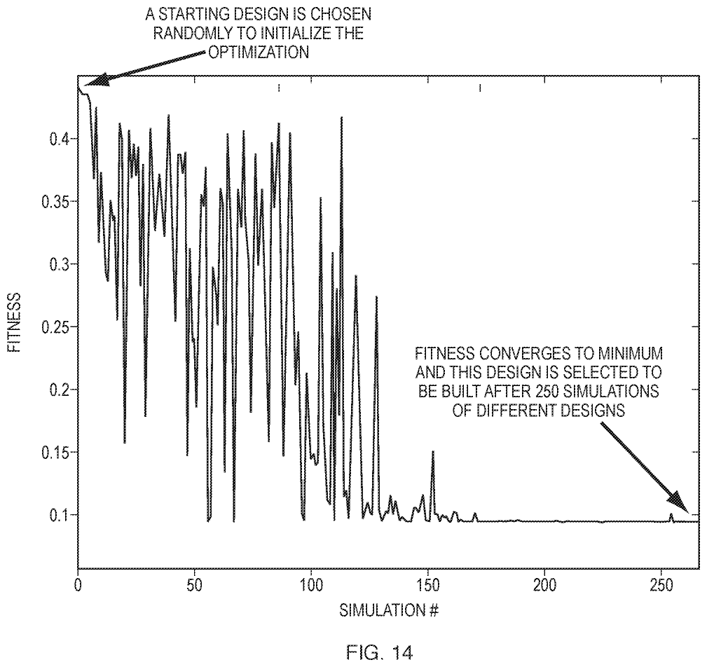

FIG. 14 is a graph showing different fitness results corresponding to different simulations for different lens shapes, respectively. Each fitness value on the graph shown in FIG. 14 is a fitness value determined from an area for a particular lens shape, such as the area 1326 in FIG. 13. Initially, a starting design may be chosen randomly or pseudo-randomly in order to initialize the optimization process. An initial fitness value may be determined (in the example of FIG. 14, the initial fitness value is nearly 0.45). As lens shape is iteratively changed, different fitness values are determined. In the example results from simulations, illustrated in FIG. 14, over 250 lens shapes were evaluated, and a final fitness value converged to a minimum, approximately 0.1. The lens shape corresponding to the final, converged minimum fitness value 0.1 may be chosen as the best lens shape to achieve the desired, goal beam directivity pattern illustrated by the dashed line in FIG. 13.

As such, with a model and fitness function established, an optimization may be run for a chosen number of iterations. A user may visually inspect fitness results to determine if an optimization process is converging to an optimized value. Alternatively, in some embodiment procedures, convergence may be determined automatically. The optimization process illustrated in FIG. 14 may be run several times with different randomized, initialized lens shapes in order to ensure that an optimization process is converging to a global minimum rather than only a local minimum.

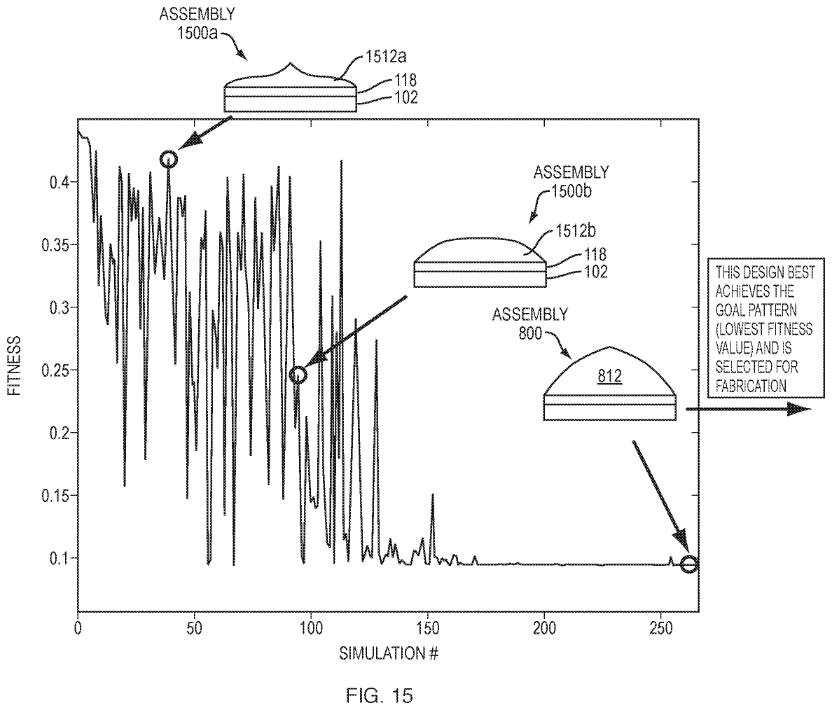

FIG. 15 illustrates how various lens shape designs may be determined from a simulation process such as the process described above. In the graph in FIG. 15, which shows the same results that are illustrated in FIG. 14, each point on the line represents the fitness of a different Bézier curve design for an acoustic lens. Any design method may be used, as long as the design can be defined as a discrete set of N variables. These N variables are passed to an optimization method as inputs. In the example illustrated in FIG. 15, the design is described as a four-term Bézier curve polynomial. The four coefficients of the polynomial serve as the variables. As illustrated in FIG. 15, an ultrasonic transducer assembly 1500a with a lens 1512a may yield a fitness value that is lower than the maximum starting value, yet is not optimized. Alternatively, a flattened dome shape for a lens 1512a may be determined from the simulation and used as part of an assembly 1500 that has a fitness value around 0.25, significantly less than the fitness value of over 0.4 for the assembly 1500a. However, the transducer assembly 800 (also illustrated in FIG. 8B), with the acoustic lens 812, has the optimized lens shape for this optimization process, with the fitness value having converged to slightly less than 0.1. After this optimization process, an acoustic transducer may be assembled using an acoustic lens that is fabricated according to the optimized shape determined in a simulation like that shown in FIG. 15.

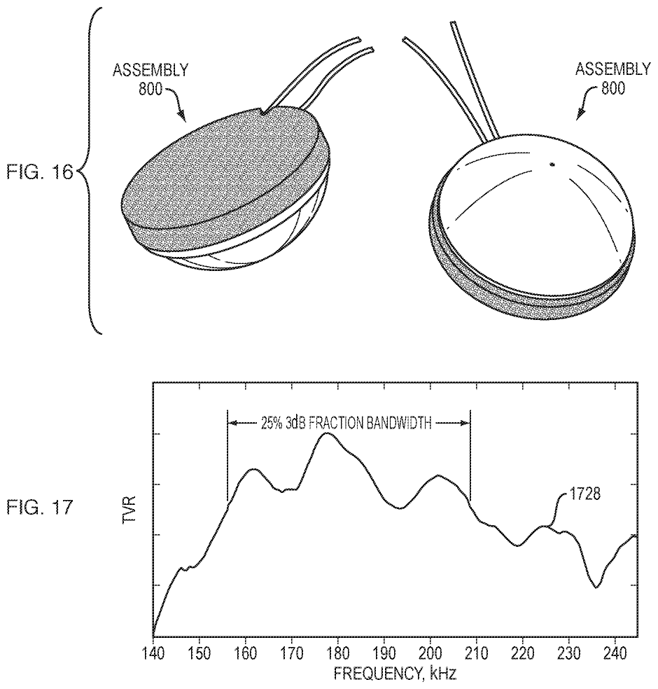

FIG. 16 is an illustration or photograph of the assembly 800, in perspective, from the bottom (left) and the top (right) of the assembly after fabrication. FIG. 16 shows the assembly 800 with the optimized lens 812 that is fabricated according to the optimized polynomial shape determined from the fitness calculations of FIG. 15.

The optimal polynomial shape selected from a simulation optimization process may be used to generate the lens shape in a CAD program. Many acoustic lens shapes, such as the shape of the lens 812, are axisymmetric and can be easily machined by a CNC lathe, for example. The lens may be laminated onto a PZT transducer disk with a matching layer in between. The stack may then be encapsulated in a urethane encapsulation inside of a housing to form a final transducer.

FIG. 17 is a graph showing an example TVR 1728 of an embodiment acoustic transducer assembly. The graph shows TVR (in dB) as a function of frequency (in kHz) for the transducer. The transducer has a peak in TVR at 178 kHz. FIG. 17 also illustrates example 3 dB fractional bandwidth of the TVR 1728. For example, the TVR has a 3 dB fractional bandwidth of 0.25 (25%, expressed as a percentage). This is calculated by dividing the effective bandwidth at 3 dB (the full width of the spectrum 1728 between the frequencies where the strength of the spectrum in TVR is 3 dB lower than at the peak value) divided by the center frequency (in this example, 178 kHz), resulting in the value 0.25. This may by multiplied by 100 to express it as the percentage 25%. In some embodiments, a transducer assembly has a TVR that has an effective 3 dB fractional bandwidth greater than 10%. TVR in other embodiments may have an effective 3 dB fractional bandwidth greater than 20%, for example. In still other embodiments, the TVR in embodiment assemblies may have an effective 3 dB fractional bandwidth greater than 30%. Further, in additional embodiments, the TVR may have an effective 3 dB fractional bandwidth greater than 40%.

### Example Bézier Functions and Widebeam Shapes

Embodiment acoustic transducer assemblies may have cross-sectional profiles defining various polynomial shapes. Bézier curves are particularly useful in the acoustic lens optimization procedures described above, because they provide a convenient way to optimize lens geometry in simulation procedures.

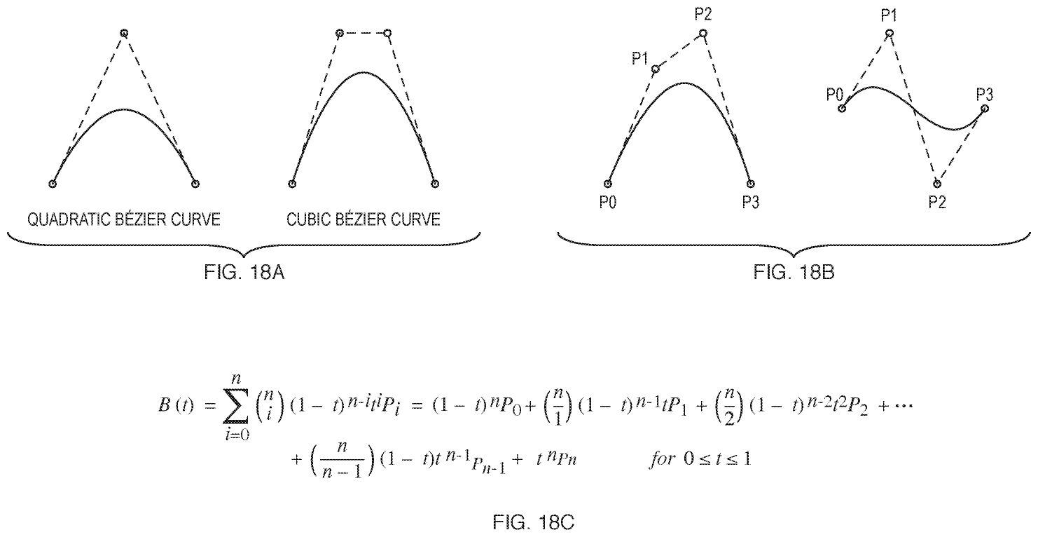

FIG. 18A is an illustration showing example Bézier shapes, including a quadradic Bézier shape (left) and a cubic Bézier shape (right).

FIG. 18B is an illustration showing two different example four-term Bézier curves, each defined by four points P₀-P₃.

FIG. 18C shows a generalized Bézier polynomial that may be used to define a curve using n different terms. Increasing the number of terms allows for greater complexity in the geometry of candidate acoustic lenses in exchange for increased optimization run time. Each curve thus defined may be used as a candidate shape for an acoustic lens in simulation, and an optimized lens shape may then be implemented in a physical acoustic lens shape (e.g., machined from a block of syntactic foam).

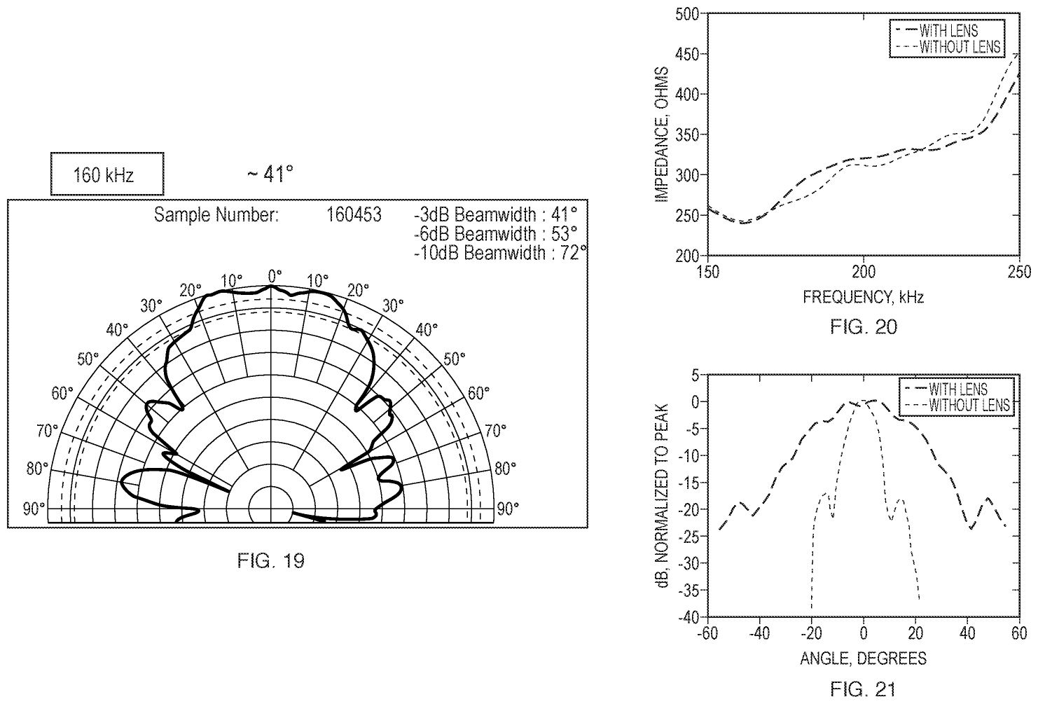

FIG. 19 is a polar graph showing an example acoustic broad beam directivity pattern that may be produced by one embodiment acoustic transducer assembly. The pattern may be calculated in simulations, as is understood by those skilled in the art. Various beam widths may be readily determined from the pattern, as is also understood by those of skill in the art. In the example shown, for a 160 kHz drive signal, the −3 dB beam width is approximately 41°, the −6 dB beam width is approximately 53°, and the −10 dB beam width is approximately 72°.

FIG. 20 is a graph illustrating an overlay of electrical impedances for two different transducer assemblies, which are identical except that one transducer is combined with an acoustic lens according to an embodiment, while the other is not. Electrical impedance magnitudes were measured. The closely matching impedance magnitudes demonstrate the expected result for when a lens material is selected to have an acoustic impedance that closely matches the acoustic impedance of water. Typically adding material to the front of a transducer will have a significant impact on the impedance magnitude, but not in the case where the acoustic impedance of the lens material and the transmission mediums are closely matched in accordance with the teachings herein. The impedance magnitude is unchanged, but the beam width of the transducer increases significantly when the lens is added.

FIG. 21 is a graph showing an overlay of directivity pattern measurements for the two different transducers referenced in connection with FIG. 20. FIGS. 20-21 illustrate that embodiment transducer assemblies that include the addition of an acoustic lens may provide a significant increase in beam width compared with an assembly that lacks an acoustic lens, and, advantageously, the lens may have negligible impact on acoustic impedance over a wide frequency range of operation.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A transducer assembly comprising:
an ultrasonic transducer element having an acoustic radiative surface, the ultrasonic transducer element configured to emit acoustic radiation over a drive frequency range, along a normal to the acoustic radiative surface, the frequency range characterized by a center frequency f_{c}; and
a divergent acoustic lens acoustically coupled to the acoustic radiative surface at a proximal surface of the acoustic lens, the acoustic lens configured to receive the acoustic radiation at the proximal surface and to transmit the acoustic radiation through a distal surface of the acoustic lens,
the acoustic lens being characterized by a maximum height h, measured from the proximal surface to the distal surface of the acoustic lens in the direction of the normal to the acoustic radiative surface, where ¾λ_{c}≤h≤2λ_{c}, where λ_{c}=cₗₑₙₛ/f_{c} is a center acoustic wavelength of the lens, and where cₗₑₙₛ is a longitudinal sound speed of the center frequency f_{c} within the acoustic lens.

2. The transducer assembly of claim 1, wherein the acoustic lens is characterized by an acoustic impedance in a range from 1.0 MegaRayls (MRayls) to 2.0 MRayls at f_{c}.

3. The transducer assembly of claim 2, wherein the acoustic lens is characterized by an acoustic impedance in a range from 1.25 MRayls to 1.75 MRayls at f_{c}.

4. The transducer assembly of claim 1, wherein the longitudinal sound speed cₗₑₙₛ is greater than 2000 m/s.

5. The transducer assembly of claim 1, wherein the acoustic lens is formed of a syntactic foam material.

6. The transducer assembly of claim 1, wherein the acoustic lens is formed of a composite material.

7. The transducer assembly of claim 6, wherein the acoustic lens is formed of carbon fiber or glass fiber.

8. The transducer assembly of claim 1, wherein, in a cross section of the acoustic lens, the distal surface of the acoustic lens is defined by a polynomial of second order to tenth order.

9. The transducer assembly of claim 8, wherein the polynomial is of third order to tenth order.

10. The transducer assembly of claim 9, wherein the polynomial is of third order to fifth order.

11. The transducer assembly of claim 1, wherein, in a cross section of the acoustic lens, the distal surface of the acoustic lens is defined by one or more Bézier curves.

12. The transducer assembly of claim 1, wherein the transducer assembly has a transmit voltage response (TVR) that has a 3 dB fractional bandwidth greater than 10%.

13. The transducer assembly of claim 12, wherein the TVR has a 3 dB fractional bandwidth greater than 20%.

14. The transducer assembly of claim 13, wherein the TVR has a 3 dB fractional bandwidth greater than 30%.

15. The transducer assembly of claim 14, wherein the TVR has a 3 dB fractional bandwidth greater than 40%.

16. The transducer assembly of claim 1, wherein an acoustic beam of the acoustic radiation output from the acoustic lens is characterized by a −3 dB beam divergence in a range from about 15° to about 40°.

17. The transducer assembly of claim 16, wherein the −3 dB beam divergence is in a range from about 20° to about 30°.

18. The transducer assembly of claim 1, wherein the center frequency f_{c} is on the order of 200 kHz.

19. The transducer assembly of claim 1, wherein the ultrasonic transducer element is formed of a ceramic piezoelectric material.

20. The transducer assembly of claim 1, further including an acoustic matching layer, wherein the acoustic lens is acoustically coupled to the acoustic radiative surface via the matching layer.

21. The transducer assembly of claim 1, wherein the acoustic lens is acoustically coupled to the acoustic radiative surface via a physical contact between the proximal surface of the acoustic lens and the acoustic radiative surface.

22. The transducer assembly of claim 1, wherein the ultrasonic transducer element is further configured to emit the acoustic radiation using a fundamental thickness mode of the ultrasonic transducer element.

23. The transducer assembly of claim 1, wherein the ultrasonic transducer element is further configured to emit the acoustic radiation using a harmonic of a fundamental thickness mode of the ultrasonic transducer element.

24. A transducer assembly comprising:
an ultrasonic transducer element having an acoustic radiative surface, the ultrasonic transducer element configured to emit acoustic radiation as a chirp pulse over a drive frequency range, the drive frequency range characterized by a center frequency f_{c}; and
a divergent acoustic lens acoustically coupled to the acoustic radiative surface at a proximal surface of the acoustic lens, the acoustic lens configured to receive the acoustic radiation at the proximal surface and to transmit the acoustic radiation through a distal surface of the acoustic lens,
the acoustic lens characterized by an acoustic impedance in a range from 1.0 MegaRayls (MRayls) to 2.0 MRayls at f_{c}.
